(19) United States
(12) Patent Application Publication
(10) Pub. No.: US 2008/0147539 A1
(43) Pub. Date: Jun. 19, 2008

(54) SYSTEM AND METHOD FOR AUTOMATING A PURCHASE OF FUEL, GOODS, OR SERVICES (FGS) WITHIN A RETAIL FUELING ENVIRONMENT

(75) Inventor: Philip A. Robertson, Greensboro, NC (US)

Correspondence Address: NELSON MULLINS RILEY & SCARBOROUGH, LLP, 1320 MAIN STREET, 17TH FLOOR, COLUMBIA, SC, 29201, US

(73) Assignee: GILBARCO INC., Greensboro, NC (US)

(21) Appl. No.: 11/611,438

(22) Filed: Dec. 15, 2006

(51) Int. Cl. G06Q 40/00

(52) U.S. Cl. 705/39; 221/1

(57) ABSTRACT

Methods and systems for automating a purchase of fuel, goods, or services (FGS) for a customer within a retail fueling environment are disclosed. According to one method, an automated transaction is created for the purchase of a first item of the FGS at a first node of the retail fueling environment, where the retail fueling environment includes at least one fuel dispenser (FD) node and at least one automated attendant (AA) node. The automated transaction is stored. The automated transaction is recalled at a second node of the retail fueling environment. The automated transaction is completed at the second node.

### FIELD OF THE INVENTION

The present invention relates to a system and method for coordinating pre-payment and post-payment of fuel and/or goods/services (FGS) between a fuel dispenser (FD) and an automated attendant (AA) within a retail fueling environment.

### BACKGROUND OF THE INVENTION

Retail fueling environments are often associated with convenience stores and fast food restaurants where customers may purchase goods or services in addition to purchasing fuel. Within these retail fueling environments, a single person, often called an attendant, is typically hired to run the cash register to complete transactions for the purchase of fuel and/or goods/services (FGS). The attendant is also responsible for managing the pre-payment and post-payment of fuel for fueling transactions and for selling goods or services at a retail counter within the retail fueling environment.

Theft of FGS within a retail fueling environment is of concern. A co-pending application, entitled “Security system and method for determining, preventing, and/or tracking theft of the use of goods and/or services, particularly fuel at retail fueling stations,” Ser. No. 11/125,682, is incorporated hereby by reference in its entirety

Given that retail fueling environments typically have multiple fuel pumps that must be managed to complete purchase transactions, the attendant running the register is often exceptionally busy managing fuel dispensing transactions. A pump select/authorization sequence requires multiple interactions between the attendant and the system for certain transactions.

As such, customers that are attempting to make counter purchases may have to wait in lines, thereby, making the convenience store environment much less convenient. Additionally, because the attendant running the register is often so busy managing fuel dispensing transactions and customers at the retail counter, more opportunity exists for shoplifters to steal goods from the retail convenience store that is associated with the retail fueling environment.

Accordingly, there exists a need to provide an automated attendant (AA) to manage pre-payment and post-payment of FGS transactions in a retail fueling environment including a user interface that allows customers to provide their own attendant-less payment for these transactions within the retail fueling environment.

### SUMMARY OF THE INVENTION

The present invention is an automated attendant (AA) located apart from the fuel dispenser(s) (FD) in a retail fueling environment to allow a customer to make their own attendant-less payment for fuel and/or goods/services (FGS) ordered at either a FD or at the AA. This allows a customer to settle payment when not using or not able to use “pay-at-the-pump” features without having to interface with a human station operator.

The AA is used by a customer to either self pre-pay or self post-pay for FGS. The customer presents a form of identifying indicium at the AA when presenting payment for FGS. When the customer orders or receives FGS at a FD, the indicium is presented at the FD to link payment provided or to be provided at the AA for the transaction. In this manner, a customer desiring to pay for the FGS can do so either before or after fulfillment and on his or her own without interaction with or assistance from a human operator or attendant. The AA automatically links and settles the charges for FGS at the correct FD. Settlement times are lessened, thereby resulting in increased station throughput and an improved customer satisfaction.

As such, a customer can start their own transaction and pay it out with cash or credit at the AA without intervention of the attendant. Additionally, by recalling the transaction with a bar code, key tag, credit card, fingerprint scan, or other indicia, easier transaction processing for the customer is provided. For example, it is often difficult for customers to remember what pump they used when they show up to pay for the transaction. The present invention alleviates this problem by providing a transaction processing approach that automatically recalls a transaction at an AA without intervention of the attendant. Alternatively, the customer may request the attendant to recall the transaction and complete the transaction at a point-of-sale (POS) terminal operated by the attendant.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is a schematic diagram of an exemplary retail service station environment including automated attendants (AAs) to increase convenience for customers of the retail service station environment;

FIG. 2 illustrates the AA in more detail for use in a retail fueling environment according to the present invention;

FIG. 3 illustrates a detailed view of an exemplary fuel dispenser (FD) including a user interface that may be used in conjunction with the AA to perform automated pre-paid and post-paid fuel and/or goods/services (FGS) transactions for customers within the retail fueling environment;

FIG. 4 illustrates a block diagram of an exemplary control system associated with the AA including components that are also included in an exemplary control system for a FD;

FIG. 5A illustrates a first portion of an exemplary process that may be executed on an AA to facilitate pre-paid and post-paid FGS transactions in a retail fueling environment;

FIG. 5B illustrates a second portion of an exemplary process that may be executed on an AA to facilitate pre-paid and post-paid FGS transactions in a retail fueling environment;

FIG. 6A illustrates a first portion of an exemplary process that may be executed on a FD to facilitate pre-paid and post-paid FGS transactions in the retail fueling environment; and

FIG. 6B illustrates a second portion of an exemplary process that may be executed on a FD to facilitate pre-paid and post-paid FGS transactions in the retail fueling environment.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is an automated attendant (AA) located apart from the fuel dispenser(s) (FD) in a retail fueling environment to allow a customer to make their own attendant-less payment for fuel and/or goods/services (FGS) ordered at either a FD or at the AA. This allows a customer to settle payment when not using or not able to use “pay-at-the-pump” features without having to interface with a human station operator.

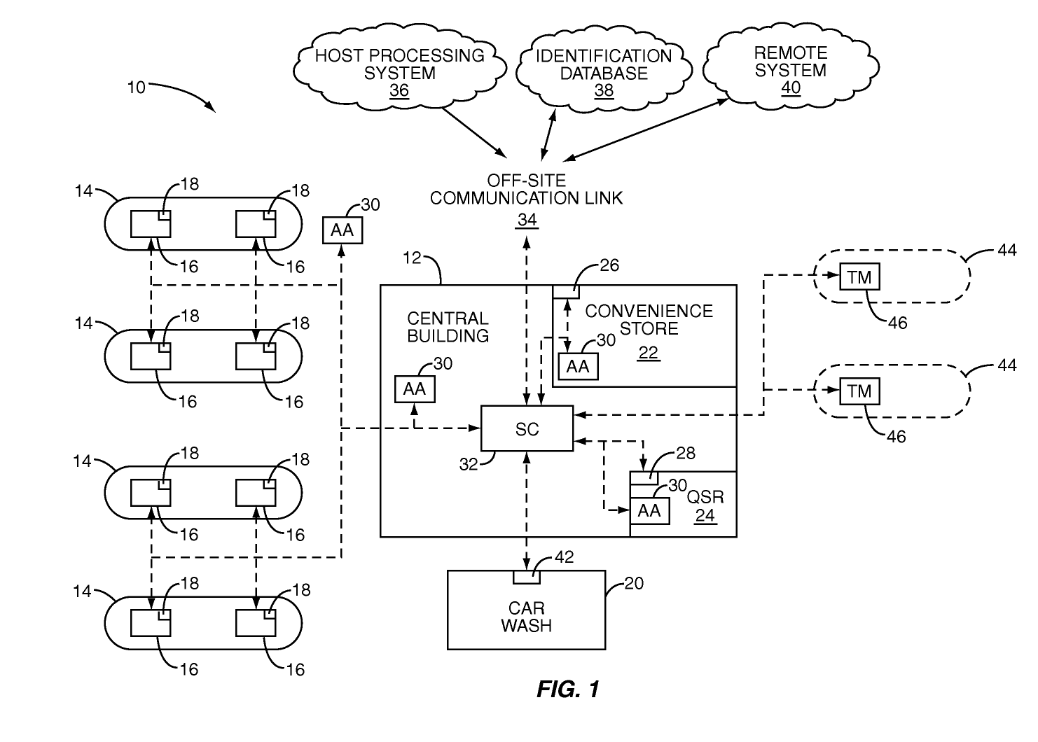

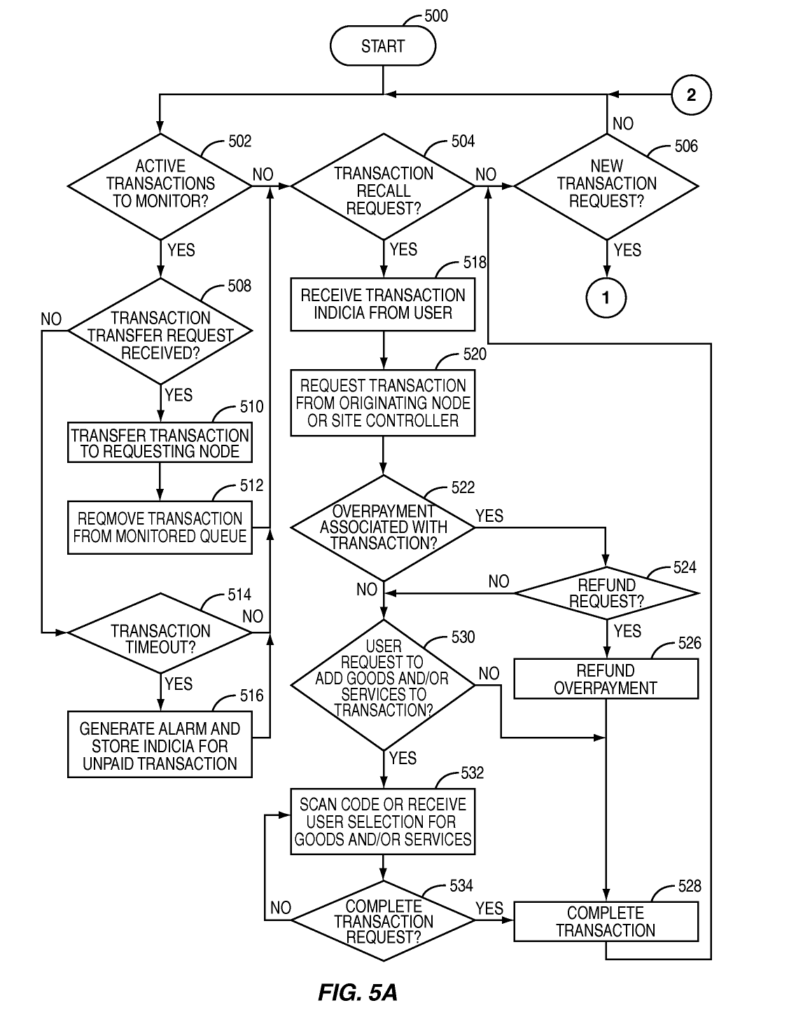

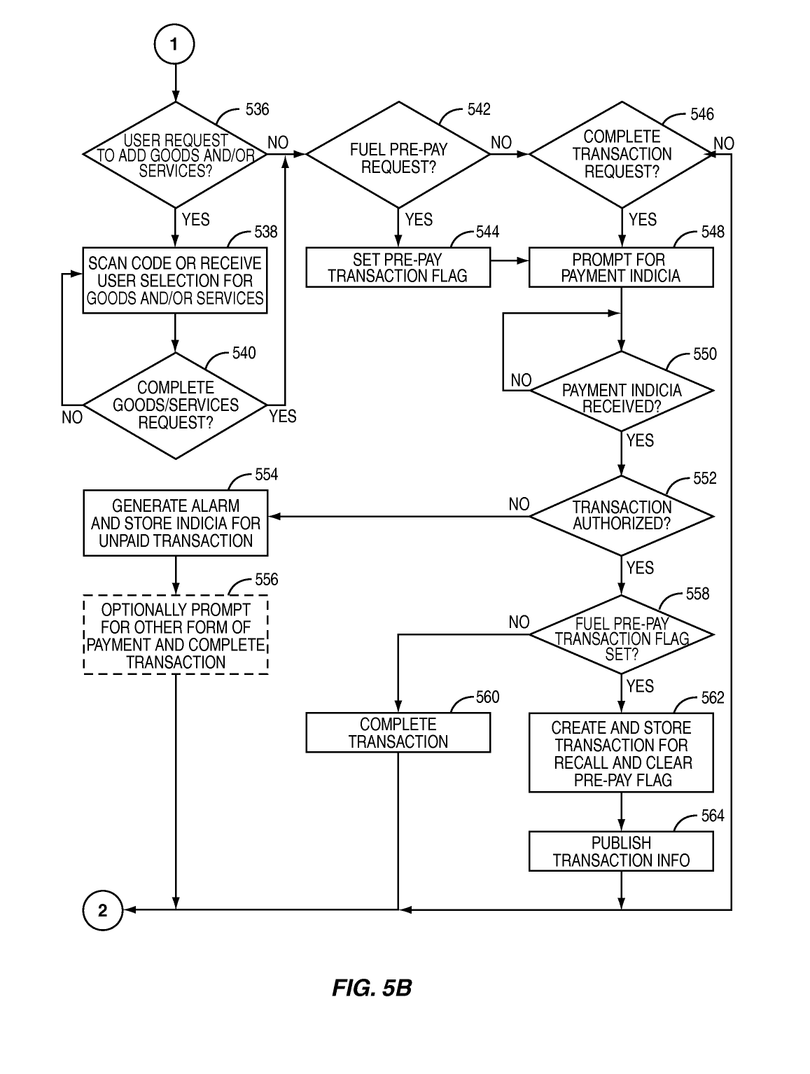

The AA is used by a customer to either self pre-pay or self post-pay for FGS. The customer presents a form of identifying indicium at the AA when presenting payment for FGS. When the customer orders or receives FGS at a FD, the indicium is presented at the FD to link payment provided or to be provided at the AA for the transaction. In this manner, a customer desiring to pay for the FGS can do so either before or after fulfillment and on his or her own without interaction with or assistance from a human operator or attendant. The AA automatically links and settles the charges for FGS at the correct FD. Settlement times are lessened, thereby resulting in increased station throughput and an improved customer satisfaction. FIGS. 1-4 introduce examples of physical elements and operation of the invention begins with FIG. 5.

As such, a customer can start their own transaction and pay it out with cash or credit at the AA without intervention of the attendant. Additionally, by recalling the transaction with a bar code, key tag, credit card, fingerprint scan, or other indicia, easier transaction processing for the customer is provided. For example, it is often difficult for customers to remember what pump they used when they show up to pay for the transaction. The present invention alleviates this problem by providing a transaction processing approach that automatically recalls a transaction at an AA without intervention of the attendant. Alternatively, the customer may request the attendant to recall the transaction and complete the transaction at a point-of-sale (POS) terminal operated by the attendant.

FIG. 1 is a schematic diagram of an exemplary retail service station environment including automated attendants (AAs) in accordance with disclosed embodiments of the present invention to increase convenience for customers of the retail service station environment. An exemplary retail fueling environment 10 is illustrated. The retail fueling environment 10 includes a central building 12, a plurality of fueling islands 14, each including multiple fuel dispensers (FDs) 16 having user interfaces 18, and a car wash 20.

The central building 12 need not be centrally located within the retail fueling environment 10, but rather is the focus of the retail fueling environment 10, and may house a convenience store 22 and/or a quick serve restaurant (QSR) 24 therein. Both the convenience store 22 and the QSR 24 may include point-of-sale (POS) terminals 26 and 28, respectively.

One or more AAs are provided within the retail fueling environment 10. Referring to FIG. 1, one of the AAs 30 is illustrated in the forecourt area of the retail fueling environment in a location proximate to the FDs 16. By placing this AA 30 in the forecourt area, a customer may drive or walk up to the AA 30 and initiate a transaction prior to entering the central building 12. The customer may then use another of the AAs 30 that is illustrated within the central building 12 and conveniently located near an entry/exit way of the central building 12 to complete a goods and/or services portion of a transaction. Additionally, one of the AAs 30 is illustrated within each of the convenience store 22 and the QSR 24. Other of the AAs 30 may be located in other regions of the retail fueling environment without departure from the scope of the subject matter described herein.

The AAs 30 provide convenient and automated user interaction capabilities both inside and outside of the central building 12 and within the convenience store 22 and the QSR 24. As will be described in more detail below, the AAs 30 allow customers to manage the purchase of fuel and/or goods/services (FGS) without needing to interact with an operator or attendant at the various locations.

The central building 12 further includes a site controller (SC) 32, which in an exemplary embodiment may be the G-SITE® sold by Gilbarco Inc. of Greensboro, N.C. The SC 32 may control the authorization of fueling transactions and other conventional activities, as is well understood. The SC 32 may be incorporated into a POS, such as the POS 26 and 28, if needed or desired, such that the SC 32 also acts as a POS device. Alternatively, the SC 32 may be incorporated into one of the AAs 30 and, accordingly, may act as an automated attendant. Additionally, as will be described in more detail below, the FDs 16 may also include the functionality of the AA's 30 to allow a customer to initiate or complete a FGS transaction at one of the FDs 16.

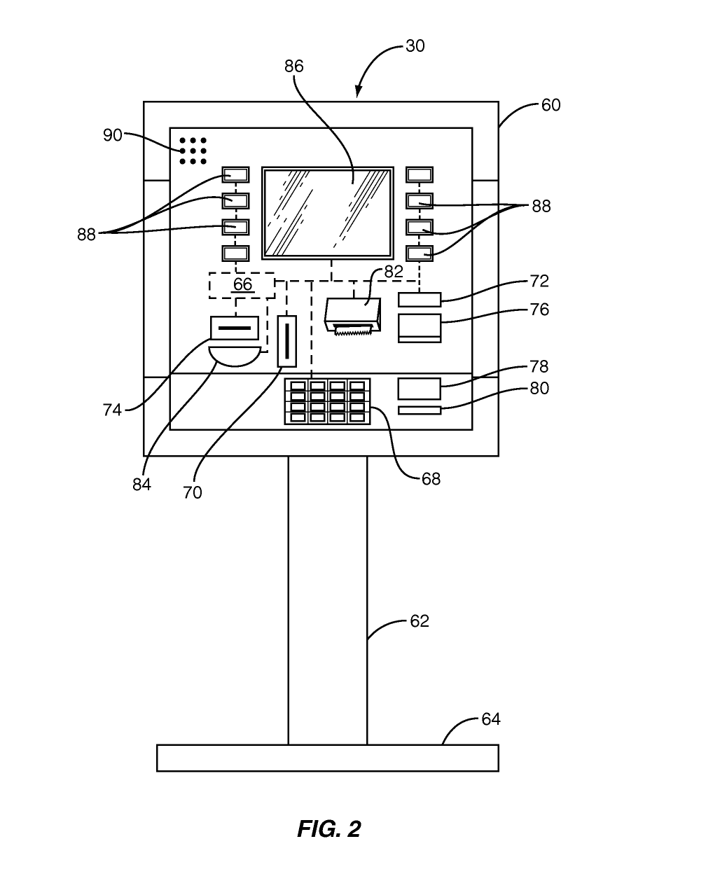

The SC 32 may perform any of the functions, as will be described in detail below beginning with FIG. 2, for a control system of the AAs 30, a user interface 18 of the FDs 16, may act in conjunction with a control system of the FDs (not described in detail herein), or may replace the control system of the FD 16. These functions include controlling FDs and transaction processing for the FD 16 and interfacing with the user interface 18 for customer interaction.

Further, the SC 32 may have an off-site communication link 34 allowing communication with a remote location for credit/debit card authorization via a host processing system 36, an identification database 38, and/or a remote system 40. The remote system 40 represents another computer, system, or device that can be used to access identification information, such as credit card and/or fingerprint data. The off-site communication link 34 may be routed through the Public Switched Telephone Network (PSTN), the Internet, both, or the like, as needed or desired.

The car wash 20 may have a POS 42 associated therewith that communicates with the SC 32 for inventory and/or sales purposes. The car wash 20 alternatively may be a stand alone unit. U.S. patent application Ser. No. 10/430,689 entitled “Service Station Car Wash,” filed on May 6, 2003, is hereby incorporated by reference as if fully set forth herein as an example of such a car wash that includes a POS terminal.

It should be noted that the car wash 20, the convenience store 22, and the QSR 24 are all optional and need not be present in a given retail fueling environment.

As described above, the plurality of fueling islands 14 may have one or more FDs 16 positioned thereon. The FDs 16 are in electronic communication with the SC 32 through a Local Area Network (LAN), pump communication loop, or other communication channel or line, or the like.

The retail fueling environment 10 also has one or more underground storage tanks (USTs) 44 adapted to hold fuel therein. As such, the USTs 44 may be a double-walled tank. Further, each USTs 44 may include a liquid level sensor or other sensor (not shown) positioned therein. The sensors may report to a tank monitor (TM) 46 associated therewith. The TM 46 may communicate with the FDs 16 (either through the SC 32 or directly, as needed or desired) to determine amounts of fuel dispensed, and compare fuel dispensed to current levels of fuel within the USTs 44 to determine if the USTs 44 are leaking. In a typical installation, the TM 46 is also positioned in the central building 12, and may be proximate to the SC 32. The TM 46 may communicate with the SC 32 for leak detection reporting, inventory reporting, or the like.

FIG. 2 illustrates the AA 30 in more detail for use in a retail fueling environment 10 according to the present invention. The AA 30 includes various combinations of subsystems to facilitate customer interaction with the AA 30. The AA 30 includes a housing 60 that is attached to a mounting post 62. The mounting post 62 is attached to a base 64 to affix the AA 30 to a mounting surface within the retail fueling environment. The base 64 is typically placed or bolted directly into the physical ground or cement of the retail fueling environment 10. As described above, in association with FIG. 1, the AA 30 may be located in a forecourt area proximate to the FDs 16 or may be located within central building 12 and/or at the car wash 20. The housing 60 is typically constructed for outdoor environments and sealed so that rain water does not penetrate inside.

The AA 30 may include a control system 66 for controlling a pre-paid or post-paid purchase transaction within the retail fueling environment 10. The control system 66 may interface with one or more input devices for payment of FGS at the retail fueling environment 10. The AA 30 may include a keypad 68. The keypad 68 may be used for selection of different types of purchase transactions available to the customer or to enter an authentication code. The types of purchase transactions include pre-paid and post-paid fueling transactions and can also include the purchase of other goods/services from the retail fueling environment 10. The keypad 68 may also be used for entry of a personal identification number (PIN) if the customer is using a debit card for payment of FGS.

When purchase transactions are created, the purchase transaction is identified with a transaction identifier. This transaction identifier may include customer identification indicia, such as a customer name, a customer account number, or other customer identification indicium. The transaction identifier may further include or be associated with a text-based designation in either an alpha-based format, a numeric format, or an alphanumeric format. This text-based designator may be used by the customer to recall the purchase transaction at another terminal within the retail fueling environment. Further, a coded sequence, such as a bar code sequence may be associated with the transaction identifier to allow a transaction receipt to be printed at one terminal and scanned at another terminal to recall and complete the purchase transaction.

The AA 30 may also contain a magnetic strip card reader 70 for insertion of credit, debit or other magnetic strip cards for payment. Additionally, the magnetic strip card reader 70 may accept loyalty or program-specific cards that entitle the customer to a fixed credit or percentage discount or other favorable pricing on gasoline or other goods/services.

The AA 30 may also contain an input device known as a radio-frequency (RF) antenna 72. The RF antenna 72 is coupled to an RF interrogator (not shown). If the customer is tendering a radio frequency identifier (RFID) for payment of a car wash, the RF antenna 72 as controlled by the RF interrogator, will generate a field to interrogate the customer's RFID. The RFID and the RF antenna 72 will communicate using RF communications to identify the customer's account or other payment information. For more information on RFID payments and interaction at a FD, see U.S. Pat. No. 6,073,840, entitled “Fuel Dispensing and Retail System Providing for Transponder Prepayment,” issued Jun. 13, 2000, incorporated herein by reference in its entirety.

The AA 30 may also include other payment or transactional type devices to receive payment information for transaction processing associated with transactions such as a pre-paid and post-paid FGS transactions, including a bill acceptor 74, an optical reader 76, a smart card reader 78, and a biometric reader 80. The AA 30 also includes a receipt printer 82 so that a receipt with a recording of the FGS transaction carried out at the AA 30 may be generated and presented to the customer.

A change delivery device 84 may also be used to deliver change for overpayment to a customer. The overpayment could also be applied as a credit towards other purchasing within the retail fueling environment 10, such as goods and/or services from the convenience store 22.

A display 86 is used to provide information, such as transaction related prompts and advertising, to the customer. Soft keys 88 are used by the customer to respond to information requests presented to the user via the display 86. An intercom 90 is provided to generate audible cues for the customer and to allow the customer to interact with an operator or attendant in the event that the customer has a question that is not answered by the AA 30.

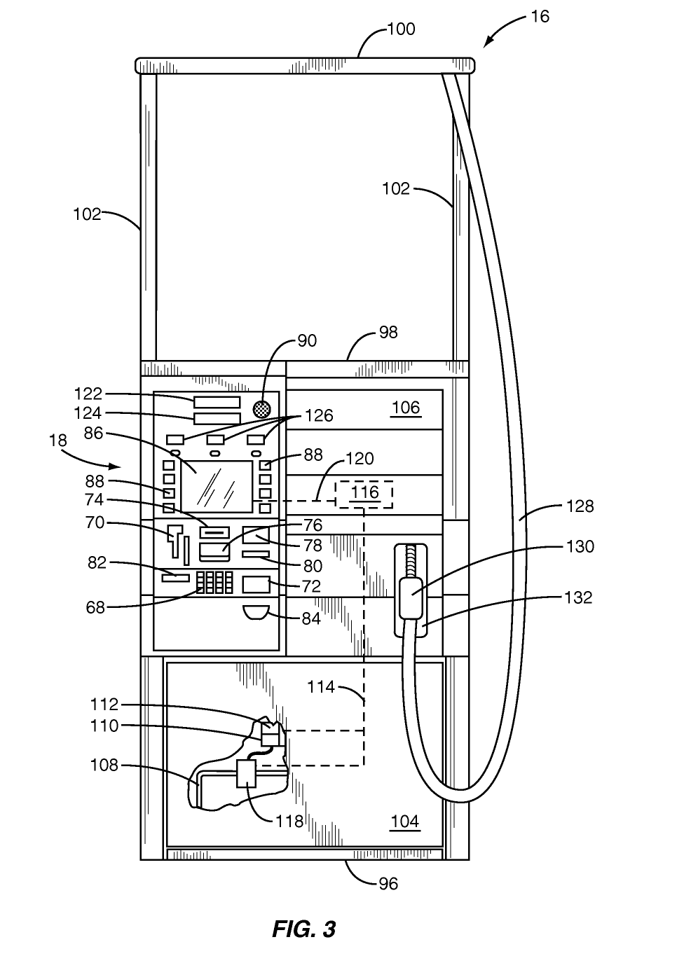

FIG. 3 illustrates a detailed view of an exemplary FD 16 including the user interface 18 that may be used in conjunction with the AA 30 to perform automated pre-paid and post-paid FGS transactions for customers within the retail fueling environment 10. The FD 16 has a base 96 and a top 98, with a canopy 100 supported by two side panels 102.

The FD 16 is subdivided into multiple compartments. A hydraulic area 104 is used to enclose hydraulic components and an electronic area 106 is used to enclose electronic components. A vapor barrier (not shown) may be used to separate the hydraulic area 104 from the electronic area 106.

Several components used to control fuel flow may be housed within the hydraulic area 104. Fuel from USTs 44 (not shown) is pumped through a piping network into inlet or fuel dispensing pipes. An inlet pipe 108 provides a piping network from an UST.

When fuel is dispensed, fuel begins to travel through a meter 110, which is responsive to flow rate or volume. A pulser 112 is employed to generate a signal in response to fuel movement through the meter 110. Control/data lines 114 provide a signaling path from the pulser 112 to a control system 116. The control/data lines 114 provide signals to the control system 116 indicative of the flow rate or volume of fuel being dispensed within the meter 110. The control/data lines 114 may provide control signaling to a valve 118 that may be opened and closed to dispense and terminate dispensing of fuel, respectively.

The control system 116 includes a controller and control circuitry for transaction-level and functional processing within the FD 16. Additionally, the control system 116 uses control/data lines 120 to interact with the user interface 18 for transactional processing at the FD 16. As described above and in more detail below, the FD 16, via the user interface 18, acts in conjunction with the AA 30 to allow a customer to perform pre-paid and post-paid FGS transactions within the retail fueling environment 10.

The user interface 18 is functionally similar to and includes elements with like reference numerals that are representative of the elements described above in association with the AA 30. In addition, the FD 16 includes a transaction price total display 122 that may be used to present the customer with the price to be charged to the customer for fuel that is dispensed. A transaction gallon total display 124 may be used to present the customer with the measurement of fuel dispensed in units of gallons or liters as a volume of fuel dispensed from the FD 16. Octane selection buttons 126 are provided for the customer to select which grade of fuel is to be dispensed before dispensing is initiated.

As fuel is dispensed from the FD 16, the control system 116 receives signaling from the pulser 112 associated with the meter 110 described above during the dispensing transaction. In response to receipt of signaling from the pulser 112, the control system 116 provides transaction-level functionality within FD 16. The control system 116 collects, either directly or indirectly, meter flow measurements associated with the meter 110.

As a dispensing transaction progresses, fuel is then delivered to a hose 128 and through a nozzle 130 into the customer's vehicle (not shown). FD 16 includes a nozzle boot 132, which may be used to hold and retain the nozzle 130 when not in use. The nozzle boot 132 may include a mechanical or electronic switch (not shown) to indicate when the nozzle 130 has been removed for a fuel dispensing request and when the nozzle 130 has been replaced, signifying the end of a fueling transaction. A control line (not shown) provides a signaling path from the electronic switch to the control system 116. The control system 116 uses signaling received via the control line in order to make a determination as to when a transaction has been initiated or completed.

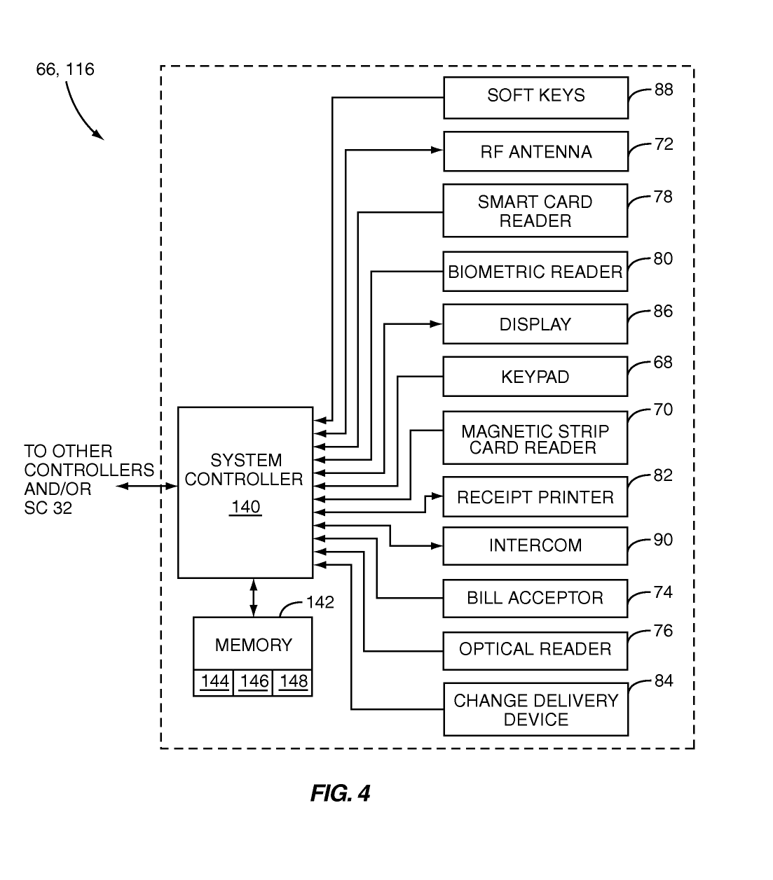

FIG. 4 illustrates a block diagram of the control system 66 associated with the AA 30. Additionally, common components of the control system 116 that are associated with the FDs 16 are also represented within FIG. 4. It should be noted that other control elements that are unique to the FDs 16, such as control sub-systems for controlling fuel delivery to a vehicle, are not illustrated within FIG. 4 to allow the present description to focus on the components that facilitate the interaction between a customer and the AA 30 and the FDs 16 to allow the customer to pre-pay or post-pay for FGS in the retail fueling environment 10. The control systems 66 and 116 of the AA 30 or the FDs 16, respectively, may communicate with each other and/or the SC 32 to complete transactions within the retail fueling environment 10.

The common elements of the user interactive elements (e.g., soft keys 88, RF antenna 72, etc.) of the AA 30 and the FDs 16 are illustrated vertically along the right side of FIG. 4. A system controller 140 is illustrated interconnected to the interactive elements. The system controller 140 operates to control pre-paid and post-paid purchase transactions within the retail fueling environment 10.

A memory 142 is connected to the system controller 140. The memory 142 may be used to store user transaction information that is associated with automated pre-paid and post-paid transactions within the retail fueling environment 10, such as identification card data and/or fingerprint identification data associated with an active transaction. The memory 142 may also include a read only memory (ROM) 144, a random access memory (RAM) 146, and a non-volatile memory 148. Transactions that are created at a node may be stored within either the RAM 146 or the non-volatile memory 148, or may be stored at the SC 32, as will be described in more detail below.

Regarding transactions within the retail fueling environment 10, any node, such as the FD 16 and the AA 30, may create a transaction for pre-payment or post-payment of FGS. Further, any node may complete a transaction once it is created. Accordingly, the processes that are executed on the nodes within the retail fueling environment 10 provide for the creation of new transactions, monitoring of active transactions, and recalling of active transactions in order to complete transaction processing. Recalling an active transaction may be performed from any node within the retail fueling environment 10. The ordering of these three exemplary initial activities may be altered without departure from the scope of the subject matter described herein.

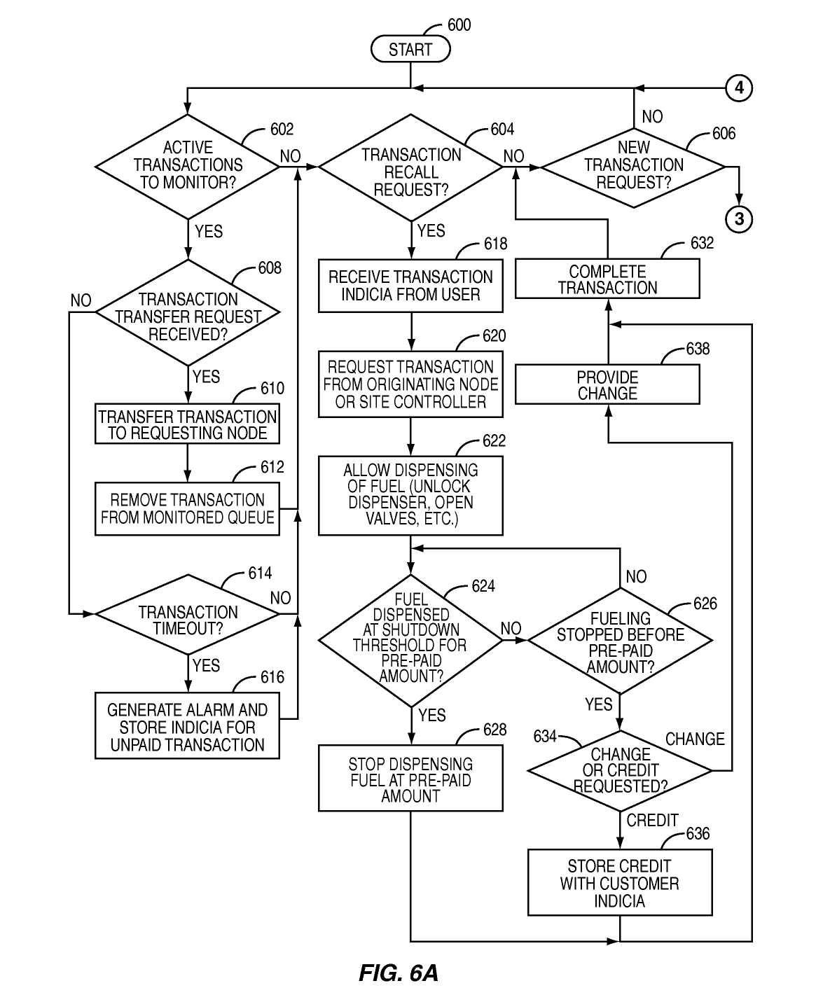

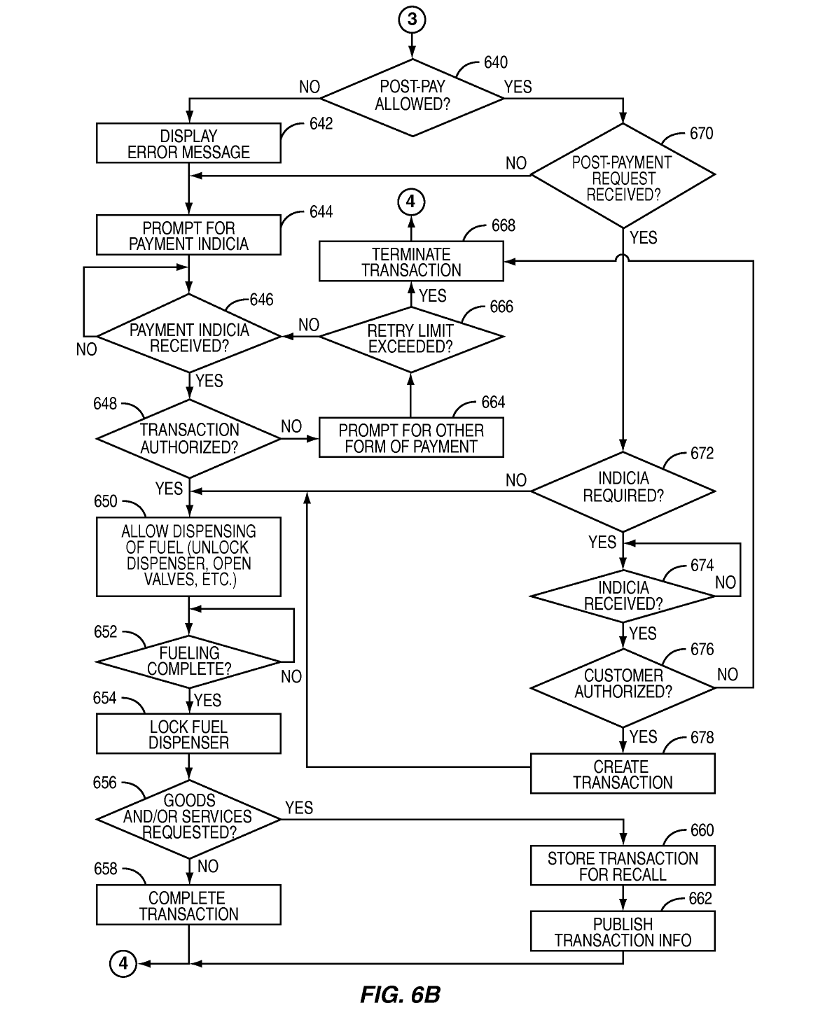

FIGS. 5A and 5B illustrate an exemplary process that may be executed on an automated assistance, such as AA 30, to facilitate pre-paid and post-paid FGS transactions in a retail fueling environment, such as the retail fueling environment 10. FIGS. 6A and 6B, described after FIGS. 5A and 5B, illustrate an exemplary process that may be executed on a FD, such as FD 16 to facilitate pre-paid and post-paid FGS transactions in the retail fueling environment 10.

As described above, the AA 30 may be located apart from the fuel dispenser(s) (FD) in a retail fueling environment to allow a customer to make their own attendant-less payment for FGS ordered at either a FD or at the AA. This allows a customer to settle payment when not using or not able to use “pay-at-the-pump” features without having to interface with a human station operator.

The process illustrated within FIGS. 5A and 5B communicates with the process illustrated within FIGS. 6A and 6B to transfer active transactions between a creating and a terminating transactional node. To ease illustration and to alleviate congestion within the following figures, certain prompts to the customer are not explicitly depicted within the figures. It is understood that whenever a process waits for input from a customer or receives a request from the customer, an associated prompt is displayed to alert the customer with respect to the requested information or that an associated selection opportunity has been presented to the customer so that the customer may make the appropriate selection. For example, should the process make a determination that goods and/or services are requested by the customer, it is assumed that an appropriate selection opportunity was made available to the customer.

Regarding FIGS. 5A and 5B, the process starts at 500. The process includes a high-level loop that operates as follows. The process monitors active transactions (decision point 502), responds to transaction recall requests from a customer (decision point 504), and responds to new transaction requests from a customer (decision point 506). The process iterates until there is a transaction to monitor, a request is presented to recall an active transaction, or a new transaction is requested. The process may further be sequential in operation or may be interrupt-driven without departure from the scope of the subject matter described herein.

Because monitoring of active transactions will help to prevent customers from requesting a post-payment of FGS and avoiding payment, monitoring of active FGS transactions will be described before the creation of a new transaction is described. Once a transaction is created, the node upon which the transaction is created can monitor the active transaction or may transfer the transaction to another node for monitoring. Alternatively, the SC 32 may monitor all active transactions from a central point without departure from the scope of the subject matter described herein. For purposes of illustration, it will be assumed that the node at which a transaction is created will monitor a transaction that is created until another node requests a transfer of the transaction. Once a transfer is completed, the receiving node will then monitor any active transactions associated with it.

Accordingly, when an active transaction exists to be monitored (decision point 502), the process determines whether a transaction transfer request has been received from another node within the retail fueling environment 10 (decision point 508). When a transaction transfer request has been received, the process transfers the active transaction to the requesting node (step 510) and removes the transaction from its monitored queue of active transactions (step 512).

When a transaction transfer request has not been received (decision point 508), the process determines whether a transaction timeout has occurred (decision point 514). A timeout mechanism will help prevent customers from initiating a post-payment transaction without later paying for the FGS. When the process determines that a transaction timeout has occurred (decision point 514), the process generates an alarm and stores indicia for the unpaid transaction (step 516). This alarm may be generated and forwarded to the SC 32. The SC 32 may then take action, such as reporting the unpaid transaction via the off-site communication link 34 so that authorities may be alerted about the unpaid transaction.

When either a transaction timeout has not occurred (decision point 514) or the alarm has been generated and the indicia for the unpaid transaction have been stored (step 516), the process returns to the main loop where the process determines whether a transaction recall request has been received (decision point 504).

When a transaction recall request has been received, the process receives transaction indicia from the user (step 518). The transaction indicia may be received by any of the interface components described above in association with FIGS. 2 and 4. For example, a customer may use a credit card to recall a transaction by swiping the credit card in the magnetic strip card reader 70 or a printed bar code from the originating terminal may be scanned by the optical reader 76. Furthermore, any other form of recall using any of the other interfaces available on the AA 30 may be used. Additionally, printed bar codes on driver's licenses may be used as the transaction indicia to both recall the transaction and to identify the customer.

After receipt of the transaction indicia from the customer, the process searches its local database of monitored transactions (not illustrated) and requests the transaction from the originating node or from the SC 32 if it is not a local transaction (step 520). The process may also add the transaction to its queue of monitored transactions if payment for the transaction is not received during the transaction recall processing (not illustrated).

For the case of a pre-paid transaction, the process determines whether there has been an overpayment associated with the transaction (decision point 522). For example, if the transaction is a pre-paid fueling transaction, the customer may not have dispensed fuel sufficient to consume the entire amount of payment authorized. As well, the customer may have authorized payment and intend to purchase goods and/or services with the overpayment.

When there has been an overpayment, the process determines whether the customer has made a refund request (decision point 524) and if the customer has made a refund request, the process refunds the overpayment (step 526). The refund may be performed by dispensing change via the change delivery device 84. The process can then complete (e.g., settle) the transaction (step 528). The process may also remove the transaction from a monitored transaction queue if it was added to one previously (not illustrated).

When a refund request has not been issued by the customer (decision point 524) or there is no overpayment (decision point 522), the process may determine whether the customer has requested to add goods and/or services to the transaction (decision point 530). If the customer has not requested to add goods and/or services to the transaction, the process may complete the transaction (step 528), as described above. If the customer has requested to add goods and/or services to the transaction, the process scans a product code or receives a customer selection from an interface component, such as soft keys 88 (step 532).

The process determines whether the customer has requested that the transaction be completed (decision point 534) and may iteratively add new goods and/or services to the transaction (step 532) until the transaction completion request is received. When the customer has requested that the transaction be completed, the process completes the transaction (step 528).

The process may optionally request the user to authorize additional payment if the pre-payment authorization is not sufficient to cover the additional goods and/or services, but for ease of illustration, it will be assumed that the payment was sufficient and that all pre-payment authorization was used to complete the transaction. Additionally, if there were an overpayment after additional goods and/or services are purchased, the process may optionally store a credit for the customer (not illustrated) or may inquire whether the customer would like a refund (steps 524 and 526).

After the transaction is completed, the process returns to the main loop. When a new transaction has been requested (decision point 506), the process progresses to FIG. 5B and determines whether the customer has requested to add goods and/or services to the new transaction (decision point 536). When goods and/or services are requested, the process scans a product code or receives a customer selection from an interface component, such as soft keys 88 (step 538). The process determines whether the customer has requested that the goods and/or services portion of the transaction be completed (decision point 540) and may iteratively add new goods and/or services to the transaction (step 538) until the goods and/or services portion of the transaction completion request is received.

When the customer has requested that the goods and/or services portion of the transaction be completed (decision point 540) or when there has not been a request to add goods and/or services (decision point 536), the process determines whether fuel pre-payment has been requested (decision point 542). When fuel pre-payment has been requested, the process sets a fuel pre-pay transaction flag (step 544). When fuel pre-payment has not been requested, the process determines whether to complete the transaction (decision point 546).

For the case where goods and/or services were not added, there will not be an active transaction to complete and the process can return to the main loop illustrated in FIG. 5A. For the case where goods and/or services were added (decision point 536), there will be an active transaction to complete and the process prompts the customer for payment indicia (step 548). The process also prompts the customer for payment indicia (step 548) after setting the fuel pre-pay transaction flag (step 544). The prompt may be in the form of a text or graphical prompt on the display 86 or may be in the form of an audible cue over the intercom 90.

The process waits for payment indicia to be received (decision point 550) and determines whether the transaction is authorized (decision point 552) upon receipt of the payment indicia. The payment indicia may be in the form of a customer swiping a credit card at the magnetic strip card reader 70 and may include any other form of payment via any of the other payment interfaces available on the AA 30. The payment indicia may also include customer identification indicia that may then be associated with the transaction in the form of a transaction identifier, as described above and in more detail below.

It should be noted that appropriate error handling procedures may be employed at any stage within the process, for example, when a user does not enter payment indicia, to manage either a non-payment situation or general timeout procedures. These error-handling procedures are not addressed herein for ease of illustration.

When the transaction is not authorized, the process generates an alert or alarm to the operator and stores indicia for the unpaid transaction (step 554). Unlike the situation where a timeout occurs relative to an active monitored transaction, this situation may not imply that a customer has failed to pay for FGS. This situation may imply that the card is over its limit or some other problem may have occurred. In this case, the customer may be instructed to go to the POS to complete the transaction with the attendant. Additionally, the process may optionally prompt the customer for another form of payment and/or complete the transaction (step 556), as described above, and then returns to the main loop in FIG. 5A.

When the transaction is not authorized, the process determines whether the fuel pre-payment flag is set (decision point 558). If the fuel pre-payment flag is not set, the process completes (e.g., settles) the transaction (step 560), as described above. If the fuel pre-payment flag is set, the process creates and stores a transaction for later recall at a FD and clears the fuel pre-payment flag (step 562). As part of the transaction creation, the transaction may be placed in the monitored transaction queue, as described above. As well, the creation process includes associating a transaction identifier with the transaction that may be used by a customer to recall the transaction at another terminal within the retail fueling environment. As described above, the transaction identifier may include customer identification indicia, a text-based designation including alpha and/or numeric characters, and/or a bar coded sequence. The customer is provided with the transaction identifier, for example, via the display 86 or the receipt printer 82, so that the transaction may be recalled at another terminal within the retail fueling environment. When the receipt printer is used to provide the transaction identifier to the customer, the printed transaction identifier may be in the form of a bar code or a combination of alpha and/or numeric characters.

The process then publishes (e.g., distributes) the transaction information (step 564) so that another AA 30 or a FD 16 can complete the transaction and returns to the main loop illustrated in FIG. 5A. Distributing of the transaction information may include distributing a transaction identifier and/or transaction indicia at the SC 32 to provide a centralized repository from which to recall transactions. Furthermore, when a centralized monitoring approach is used, such as the monitoring of active transactions at the SC 32 described above, distributing the transaction information may include transferring the active transaction to the SC 32 and having the SC 32 distribute the transaction information.

If a distributed repository is preferred, distributing the transaction indicia may include monitoring a communication buss for a transaction recall requests from another node or nodes and fulfilling those requests, such that each node acts as a part of a distributed repository for transactions created at the node. A distributed repository may also include broadcasting the transaction identifier and/or transaction indicia to all nodes within the retail fueling environment 10 so that any node may request a recall directly from the creating node.

FIGS. 6A and 6B illustrate an exemplary process that may be executed on a FD, such as FD 16 to facilitate pre-paid and post-paid FGS transactions in the retail fueling environment 10. The process starts at 600. The process includes a high-level loop that operates as follows. The process monitors active transactions (decision point 602), responds to transaction recall requests from a customer (decision point 604), and responds to new transaction requests from a customer (decision point 606). The process iterates until there is a transaction to monitor, a request is presented to recall an active transaction, or a new transaction is requested. The process may further be sequential in operation or may be interrupt-driven without departure from the scope of the subject matter described herein.

Because monitoring of active transactions will help to prevent customers from requesting a post-payment of FGS and avoiding payment, monitoring of active FGS transactions will be described before the creation of a new transaction is described. Once a transaction is created, the node upon which the transaction is created can monitor the active transaction or may transfer the transaction to another node for monitoring. Alternatively, the SC 32 may monitor all active transactions from a central point without departure from the scope of the subject matter described herein. As described above in association with FIGS. 5A and 5B, for purposes of illustration, it will be assumed that the node at which a transaction is created will monitor a transaction that is created until another node requests a transfer of the transaction. Once a transfer is completed, the receiving node will then monitor any active transactions associated with it.

Accordingly, when an active transaction exists to be monitored (decision point 602), the process determines whether a transaction transfer request has been received from another node within the retail fueling environment 10 (decision point 608). When a transaction transfer request has been received, the process transfers the active transaction to the requesting node (step 610) and removes the transaction from its monitored queue of active transactions (step 612).

When a transaction transfer request has not been received (decision point 608), the process determines whether a transaction timeout has occurred (decision point 614). A timeout mechanism will help prevent customers from initiating a post-payment transaction without later paying for the FGS. When the process determines that a transaction timeout has occurred (decision point 614), the process generates an alarm and stores indicia for the unpaid transaction (step 616). This alarm may be generated and forwarded to the SC 32. The SC 32 may then take action, such as reporting the unpaid transaction via the off-site communication link 34 so that authorities may be alerted about the unpaid transaction.

When either a transaction timeout has not occurred (decision point 614) or the alarm has been generated and the indicia for the unpaid transaction have been stored (step 616), the process returns to the main loop where the process determines whether a transaction recall request has been received (decision point 604).

When a transaction recall request has been received, the process receives transaction indicia from the user (step 618). The transaction indicia may be received by any of the interface components described above in association with FIGS. 3 and 4. For example, a customer may use a credit card to recall a transaction by swiping the credit card in the magnetic strip card reader 70 or a printed bar code from the originating terminal may be scanned by the optical reader 76. Furthermore, any other form of recall using any of the other interfaces available on the AA 30 may be used. Additionally, printed bar codes on driver's licenses may be used as the transaction indicia to both recall the transaction and to identify the customer.

After receipt of the transaction indicia from the customer, the process searches its local database of monitored transactions (not illustrated) and requests the transaction from the originating node or from the SC 32 if it is not a local transaction (step 620). The process may also add the transaction to its queue of monitored transactions if payment for the transaction is not received during the transaction recall processing (not illustrated).

Upon receipt of the transaction from the requesting node, the process allows dispensing of fuel (step 622) by performing various operations, such as unlocking the dispenser if a lock is present, opening valves, and any other activities that enable fuel to be dispensed from the FD 16. As fuel is dispensed, the process monitors a pre-payment shutdown threshold (decision point 624). When the pre-payment shutdown threshold has not been reached, the process determines whether fueling has been stopped prior to reaching the pre-paid amount (decision point 626), which would indicate that a refund or credit is due to the customer. The process iteratively checks the pre-payment threshold and for termination of the fueling transaction by the customer until either the pre-payment threshold has been reached or fueling has been stopped prior to reaching the pre-payment threshold.

When the pre-payment threshold has been reached (decision point 624), the process slows fuel delivery by beginning to close dispensing valves and stops dispensing fuel at the pre-paid amount (step 628). The FD is then locked if a lock is present and the valve(s) closed (step 630). The transaction is then completed (e.g., settled) (step 632), as described above.

When fueling has been stopped by the customer prior to reaching the pre-payment threshold (decision point 626), a refund or credit for the customer will be due. The process determines whether the customer wants a change from the pre-paid transaction or a credit (decision point 634). When the customer selects a credit, the credit is stored with customer identification indicium for future use (step 636). This credit may be recalled during a future transaction recall request, as described above. When the customer selects refund of the difference between the dispensed fuel and the pre-paid amount, change is provided to the customer (step 638). The change may be provided to the customer via the change delivery device 84.

When either the credit has been stored or change has been dispensed, the process locks the FD and completes the transaction (step 632), as described above. After the transaction is completed, the process returns to the main loop.

When a new transaction has been requested (decision point 606), the process progresses to FIG. 6B and determines whether post-payment has been configured for the FD 16 (decision point 640). Post-payment for a FD may be enabled and disabled by an operator within the retail fueling environment 10 or may be automated to allow post-payment, for example, only during daylight hours. Accordingly, post-payment may be authorized during certain portions of a day and not during other portions of a day. A description of the process behavior for the situation where post-payment is allowed at the FD 16 will be described after the following description of the situation where post-payment is not allowed.

When post-payment is not allowed at the FD 16 (decision point 640), an alert/error message is displayed to the customer indicating that the customer must either pre-pay with the operator or pre-pay at the FD 16 (step 642). The customer is prompted for payment indicia (step 644).

The process then waits for the customer to present payment indicia (decision point 646). For example, the customer may present a smart card at the smart card reader 78 for payment purposes. The payment indicia may also include customer identification indicia that may then be associated with the transaction in the form of a transaction identifier, as described above and in more detail below.

Though not illustrated in FIG. 6B, should the customer decide to pay for the FGS transaction via an operator within the retail fueling environment 10, an appropriate timeout may occur and the process may terminate the FGS transaction. Alternatively, the process may wait for the operator to authorize the transaction. Additional error handling procedures may be implemented to accommodate, for example, a situation where a customer decides not to proceed with the FGS transaction.

When the customer has presented a payment indicia to either the FD 16 or to the operator, the process may determine whether the transaction has been authorized (decision point 648). When the transaction has been authorized by either method, the process allows dispensing of fuel (step 650) by performing various operations, such as unlocking the dispenser if a lock is present, opening valves, and any other activities that enable fuel to be dispensed from the FD 16.

The process waits for the customer to finish dispensing fuel (decision point 652). When the customer has finished dispensing fuel, the FD is then locked if a lock is present and the valve(s) are closed (step 654).

The process then determines whether the customer desires to add goods and/or services to the transaction (decision point 656). When the customer does not desire additional goods and/or services, the process completes (e.g., settles) the transaction (step 658) and returns to the main loop of FIG. 6A. When the customer does wish to purchase additional goods and/or services, the process stores the transaction for later recall (step 660) and publishes (e.g., distributes) the information, as described above, so that the transaction may be recalled from another node (step 662). After the information is distributed, the process returns to the main loop of FIG. 6A. Reference to FIGS. 5A and 5B and the associated description above illustrate recall of a FGS transaction at the AA 30.

Referring back to a situation where the transaction has not been authorized (decision point 648), the customer is prompted for another form of payment (step 664) and a determination is made as to whether a retry limit has been exceeded (decision point 666). The retry limit may be set to a reasonable number, such as three retries, to allow a customer to provide new payment and to avoid congestion at the FD 16 that may occur if the retry limit were set too high. When the retry limit has not been exceeded, the process iterates through decision point 646 to receive payment indicia, as described above. When the retry limit has been exceeded, the process terminates the transaction (step 668) and returns to the main loop of FIG. 6A. At this point the customer is instructed to interact with the operator of the retail fueling environment 10 to provide for payment.

Reference is now made to the situation where post-payment is allowed at the FD (decision point 640). The process then determines whether a request for post-payment has been received from the customer at the FD 16 (decision point 670). When a post-payment request has not been received, payment is to be made at the FD 16 and the process proceeds to prompt the customer for payment indicia (step 644), as described above.

When the customer chooses post-payment, the process initiates a post-payment transaction by determining whether customer identification indicium is required for the transaction (decision point 672). If customer identification indicium is not required, the process allows dispensing of fuel (step 650), as described above. When customer identification indicium is required for the transaction, the process waits for the customer identification indicium to be received (decision point 674). Again, appropriate timeout and error handling procedures may be implemented at any appropriate stage within the process described.

When customer identification indicium is received, a determination is made as to whether the customer is authorized to perform a post-paid transaction (decision point 676). Customer authorization may be performed in a variety of ways. For example, a check of an external database associated with fraudulent FGS transactions may be maintained by the SC 32. Additionally, the SC 32 may perform a check using the identification database 38 over the off-site communication link 34.

If the customer is determined not to be authorized to perform a post-paid transaction, the process terminates the transaction (step 668), as described above. Optionally, the attendant may authorize the transaction and allow indicia to be used to pay for fuel at an AA. If the customer is determined to be authorized to perform a post-paid transaction, the process creates a transaction (step 678). The transaction creation process includes associating a transaction identifier with the transaction that may be used by a customer to recall the transaction at another terminal within the retail fueling environment. As described above, the transaction identifier may include customer identification indicia, a text-based designation including alpha and/or numeric characters, and/or a bar coded sequence. The customer is provided with the transaction identifier, for example, via the display 86 or the receipt printer 82, so that the transaction may be recalled at another terminal within the retail fueling environment. When the receipt printer is used to provide the transaction identifier to the customer, the printed transaction identifier may be in the form of a bar code or a combination of alpha and/or numeric characters.

The process then allows fuel to be dispensed (step 650), as described above. Upon completion of the fueling process (either at step 658 or at step 662), the process returns to the main loop of FIG. 6A.

Those skilled in the art will recognize improvements and modifications to the preferred embodiments of the present invention. All such improvements and modifications are considered within the scope of the concepts disclosed herein and the claims that follow.

What is claimed is:

1. A method for automating pre-payment for a purchase of fuel by a customer within a retail fueling environment, comprising the steps of:
creating an automated transaction for the pre-payment purchase of fuel at an automated attendant (AA) node without intervention from a human operator of the retail fueling environment;
receiving payment for the fuel from the customer at the AA node;
after the aforementioned steps:
receiving a request from the customer to complete the automated transaction at a fuel dispenser;
retrieving the automated transaction at the fuel dispenser; and
settling the automated transaction.

2. The method of claim 1 further comprising dispensing the fuel at the fuel dispenser before the step of settling.

3. The method of claim 1 further comprising receiving a request from the customer to add at least one of additional goods or services to the automated transaction.

4. The method of claim 3 wherein the at least one of the additional goods or services are added to the automated transaction without intervention from the human operator of the retail fueling environment.

5. The method of claim 3 wherein the request to add the at least one of the additional goods or services to the automated transaction is received at a second AA node.

6. The method of claim 1 wherein creating the automated transaction further comprises distributing the automated transaction within a communication system associated with the retail fueling environment.

7. The method of claim 6 wherein creating the automated transaction further comprises receiving at least one customer identification indicium from the customer and associating the at least one customer identification indicium with the automated transaction.

8. The method of claim 6 wherein distributing the automated transaction further comprises sending the automated transaction including a transaction identifier to a site controller within the retail fueling environment.

9. The method of claim 8 wherein the transaction identifier includes at least one of the at least one customer identification indicium, a text-based designation associated with the automated transaction having at least one of an alpha and a numeric character, and a bar coded sequence associated with the automated transaction.

10. The method of claim 6 wherein distributing the automated transaction further comprises monitoring the communication system to determine whether a recall request for the automated transaction has been issued by another node within the retail fueling environment.

11. The method of claim 1 wherein receiving the request from the customer to complete the automated transaction at the fuel dispenser further comprises receiving a transaction identifier from the customer.

12. The method of claim 11 wherein the transaction identifier includes at least one of a customer identification indicium, a text-based designation associated with the automated transaction having at least one of an alpha and a numeric character, and a bar coded sequence associated with the automated transaction.

13. The method of claim 11 wherein retrieving the automated transaction at the fuel dispenser further comprises retrieving the automated transaction by use of the transaction identifier via the communication system.

14. The method of claim 13 wherein retrieving the automated transaction further comprises requesting the automated transaction from a site controller within the retail fueling environment using the transaction identifier.

15. The method of claim 13 wherein retrieving the automated transaction includes requesting the automated transaction from the AA node using the transaction identifier.

16. The method of claim 1 further comprising associating at least one customer identification indicium with the automated transaction.

17. The method of claim 1 further comprising determining whether an overpayment has occurred in association with the automated transaction and performing at least one of refunding change and storing a purchase credit for the customer.

18. The method of claim 17 wherein determining whether the overpayment has occurred includes determining that pre-paid fuel has not been completely dispensed from the fuel dispenser.

19. The method of claim 1 wherein settling the automated transaction further comprises requesting additional payment from the customer when the automated transaction includes a pre-paid transaction amount that is insufficient to pay for additional fuel, goods or services (FGS) that are requested by the customer.

20. A method for automating post-payment for a purchase of fuel, goods or services (FGS) within a retail fueling environment, comprising the steps of:
receiving a request from a customer to make a post-payment purchase of at least one of the FGS at a fuel dispenser (FD) within the retail fueling environment;
creating an automated transaction at the FD without intervention from a human operator of the retail fueling environment;
retrieving the automated transaction at an automated attendant (AA) node;
receiving payment for the at least one of the FGS from the customer at the AA node; and
settling the automated transaction at the AA node.

21. The method of claim 20 further comprising receiving a request from the customer to add at least one of additional goods or services to the automated transaction at the AA node.

22. The method of claim 21 wherein the at least one of the additional goods or services are added to the automated transaction without intervention from the human operator of the retail fueling environment.

23. The method of claim 20 wherein creating the automated transaction further comprises distributing the automated transaction within a communication system associated with the retail fueling environment.

24. The method of claim 23 wherein distributing the automated transaction further comprises sending the automated transaction including a transaction identifier to a site controller within the retail fueling environment.

25. The method of claim 24 wherein the transaction identifier includes at least one of a customer identification indicium, a text-based designation associated with the automated transaction having at least one of an alpha and a numeric character, and a bar coded sequence associated with the automated transaction.

26. The method of claim 23 wherein distributing the automated transaction further comprises monitoring the communication system at the FD to determine whether a recall request for the automated transaction has been issued by another node within the retail fueling environment, and wherein retrieving the automated transaction at the AA node further comprises issuing the recall request.

27. The method of claim 20 further comprising receiving a request from the customer including a transaction identifier to complete the automated transaction at the AA node and wherein retrieving the automated transaction at the AA node further comprises retrieving the automated transaction using the transaction identifier.

28. The method of claim 27 wherein the transaction identifier includes at least one of a customer identification indicium, a text-based designation associated with the automated transaction having at least one of an alpha and a numeric character, and a bar coded sequence associated with the automated transaction.

29. The method of claim 27 wherein retrieving the automated transaction further comprises requesting the automated transaction from a site controller within the retail fueling environment using the transaction identifier.

30. The method of claim 27 wherein retrieving the automated transaction includes requesting the automated transaction from the FD using the transaction identifier.

31. The method of claim 20 further comprising associating at least one customer identification indicium with the automated transaction.

32. The method of claim 20 further comprising receiving a request from the customer to receive the at least one of the FGS at the AA node.

33. The method of claim 20 further comprising monitoring the automated transaction to determine whether the customer has failed to pay for the at least one of the FGS.

34. The method of claim 33 further comprising generating an alarm when the monitoring of the automated transaction indicates that the customer has failed to pay for the at least one of the FGS.

35. The method of claim 20 further comprising determining whether at least one customer identification indicium associated with the customer is required for post-payment of the FGS.

36. The method of claim 35 comprising determining whether the at least one customer identification indicium indicate that the customer is authorized for post-payment of the FGS.

37. An automated attendant (AA) for providing automated transaction management for a customer within a retail fueling environment, the AA comprising:
a communication interface adapted to communicate with at least one of a plurality of automated transaction processing nodes within the retail fueling environment; and
a control system adapted to:
receive a request from the customer for pre-payment of fuel within the retail fueling environment;
create an automated transaction without intervention from a human operator of the retail fueling environment;
receive payment for the fuel from the customer; and
distribute the automated transaction via the communication interface to allow the transaction to be settled by one of the at least one of a plurality of automated transaction processing nodes.

38. The AA of claim 37 wherein the control system is further adapted to receive a request from the customer to add at least one of additional goods or services to the automated transaction.

39. The AA of claim 38 wherein the control system is further adapted to add the at least one of the additional goods or services to the automated transaction without intervention from the human operator of the retail fueling environment.

40. The AA of claim 37 wherein, in being adapted to distribute the automated transaction, the control system is further adapted to send the automated transaction including a transaction identifier to a site controller within the retail fueling environment.

41. The AA of claim 40 wherein the control system is further adapted to associate the transaction identifier with at least one of a customer identification indicium, a text-based designation associated with the automated transaction having at least one of an alpha and a numeric character, and a bar coded sequence associated with the automated transaction.

42. The AA of claim 37 wherein, in being adapted to distribute the automated transaction, the control system is further adapted to monitor the communication interface to determine whether a recall request for the automated transaction has been issued by another node within the retail fueling environment.

43. The AA of claim 37 wherein the control system is further adapted to receive at least one customer identification indicium and to associate the at least one customer identification indicium with the automated transaction.

44. A fuel dispenser (FD) for providing automated post-payment transaction management for a customer within a retail fueling environment, the FD comprising:
a communication interface adapted to communicate with at least one of a plurality of automated transaction processing nodes within the retail fueling environment; and
a control system adapted to:
receive an indication from the customer for post-payment of fuel, goods or services (FGS) within the retail fueling environment;
retrieve an automated post-payment transaction previously created at one of the plurality of automated transaction processing nodes without intervention from a human operator of the retail fueling environment;
receive payment for the FGS from the customer; and
settle the automated post-payment transaction.

45. The FD of claim 44 wherein the control system is further adapted to receive a request from the customer to add at least one of additional goods or services to the automated post-payment transaction.

46. The FD of claim 45 wherein the control system is further adapted to add the at least one of the additional goods or services to the automated post-payment transaction without intervention from the human operator of the retail fueling environment.

47. The FD of claim 44 wherein the control system is further adapted to receive a request from the customer including a transaction identifier to complete the automated post-payment transaction and to retrieve the automated post-payment transaction using the transaction identifier.

48. The FD of claim 47 wherein the control system is further adapted to associate the transaction identifier with at least one of a customer identification indicium, a text-based designation associated with the automated post-payment transaction having at least one of an alpha and a numeric character, and a bar coded sequence associated with the automated post-payment transaction.

49. The FD of claim 47 wherein, in being adapted to retrieve the automated post-payment transaction, the control system is further adapted to request the automated post-payment transaction from a site controller within the retail fueling environment using the transaction identifier.

50. The FD of claim 47 wherein, in being adapted to retrieve the automated post-payment transaction, the control system is further adapted to request the automated post-payment transaction from the one of the plurality of automated transaction processing nodes using the transaction identifier.

51. The FD of claim 44 wherein the control system is further adapted to monitor the automated post-payment transaction to determine whether the customer has failed to pay for the FGS.

52. The FD of claim 44 wherein the control system is further adapted to generate an alarm when monitoring of the automated post-payment transaction indicates that the customer has failed to pay for the FGS.

53. The FD of claim 44 wherein the control system is further adapted to receive payment from the customer for the FGS.

54. The FD of claim 44 wherein the control system is further adapted to dispense the fuel before the step of settles the automated post-payment transaction.
